(19) United States
(12) Patent Application Publication
(10) Pub. No.: US 2025/0233378 A1
(43) Pub. Date: Jul. 17, 2025

(54) CHAMBER OF GAS LASER APPARATUS, GAS LASER APPARATUS, AND ELECTRONIC DEVICE MANUFACTURING METHOD

(71) Applicant: Gigaphoton Inc., Tochigi (JP)

(72) Inventors: Makoto TANAKA, Oyama-shi (JP); Tsukasa HORI, Oyama-shi (JP); Masahide KATO, Oyama-shi (JP)

(73) Assignee: Gigaphoton Inc., Tochigi (JP)

(21) Appl. No.: 19/096,865

(22) Filed: Apr. 1, 2025

Related U.S. Application Data
(63) Continuation of application No. PCT/JP2022/041455, filed on Nov. 7, 2022.

(51) Int. Cl. H01S 3/036; H01S 3/038

(52) U.S. Cl. CPC H01S 3/036; H01S 3/0381; H01S 3/0382

(57) ABSTRACT

A chamber of a gas laser apparatus, the chamber configured to encapsulate a laser gas in an internal space, includes an anode disposed in the internal space and having a longitudinal direction along a predetermined direction; a cathode disposed in the internal space and including a base and a discharge section protruding from the base toward the anode, the cathode having a longitudinal direction along the predetermined direction, the cathode being separate from and facing the anode; a cathode-side cover disposed in the internal space, being separate from a portion of the base and the discharge section, and covering the base; and a cathode-side sound absorbing member provided in a gap between the portion of the base and the cathode-side cover.

### CROSS-REFERENCE TO RELATED APPLICATIONS

The present application is a continuation application of International Application No. PCT/JP2022/041455, filed on Nov. 7, 2022, the entire contents of which are hereby incorporated by reference.

### BACKGROUND

### 1. Technical Field

The present disclosure relates to a chamber of a gas laser apparatus, a gas laser apparatus, and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from KrF and ArF excimer laser apparatuses undergoing spontaneous laser oscillation has a wide spectral linewidth ranging from 350 pm to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

PTL 1: U.S. Pat. No. 6,639,929
PTL 2: JP6-085350A
PTL 3: Japanese Patent No. 4579002
PTL 4: Japanese Patent No. 4918699
PTL 5: U.S. Patent Application Publication No. 2022/0091515

### SUMMARY

A chamber of a gas laser apparatus according to an aspect of the present disclosure may be configured to encapsulate a laser gas in an internal space. The chamber may include an anode, a cathode, a cathode-side cover, and a cathode-side sound absorbing member. The anode is disposed in the internal space. The anode has a longitudinal direction along a predetermined direction. The cathode is disposed in the internal space. The cathode includes a base and a discharge section protruding from the base toward the anode. The cathode has a longitudinal direction along the predetermined direction. The cathode is separate from and faces the anode. The cathode-side cover is disposed in the internal space, being separate from a portion of the base and the discharge section. The cathode-side cover covers the base. The cathode-side sound absorbing member is provided in a gap between the portion of the base and the cathode-side cover.

A gas laser apparatus according to another aspect of the present disclosure may include a chamber. The chamber is configured to encapsulate a laser gas in an internal space. The chamber includes an anode, a cathode, a cathode-side cover, and a cathode-side sound absorbing member. The anode is disposed in the internal space. The anode has a longitudinal direction along a predetermined direction. The cathode is disposed in the internal space. The cathode includes a base and a discharge section protruding from the base toward the anode. The cathode has a longitudinal direction along the predetermined direction. The cathode is separate from and faces the anode. The cathode-side cover is disposed in the internal space. The cathode-side cover is separate from a portion of the base and the discharge section. The cathode-side cover covers the base. The cathode-side sound absorbing member is provided in a gap between the portion of the base and the cathode-side cover.

An electronic device manufacturing method according to another aspect of the present disclosure may include: generating laser light by using a gas laser apparatus including a chamber configured to encapsulate a laser gas in an internal space; outputting the laser light to an exposure apparatus; and exposing a photosensitive substrate to the laser light in the exposure apparatus to manufacture electronic devices. The chamber includes an anode, a cathode, a cathode-side cover, and a cathode-side sound absorbing member. The anode is disposed in the internal space. The anode has a longitudinal direction along a predetermined direction. The cathode is disposed in the internal space. The cathode includes a base and a discharge section protruding from the base toward the anode. The cathode has a longitudinal direction along the predetermined direction. The cathode is separate from and faces the anode. The cathode-side cover is disposed in the internal space. The cathode-side cover is separate from a portion of the base and the discharge section. The cathode-side cover covers the base. The cathode-side sound absorbing member is provided in a gap between the portion of the base and the cathode-side cover.

### BRIEF DESCRIPTION OF DRAWINGS

Embodiments of the present disclosure will be described below only by way of example with reference to the accompanying drawings.

FIG. 1 is a diagrammatic view showing a schematic configuration example of an entire electronic device manufacturing apparatus.

FIG. 2 is a diagrammatic view showing a schematic configuration example of an entire gas laser apparatus according to Comparative Example.

FIG. 3 is a cross-sectional view of a chamber according to Comparative Example taken along a VH plane.

FIG. 4 is a cross-sectional view of a cathode and surroundings thereof shown in FIG. 3 taken along a VH plane.

FIG. 5 is a cross-sectional view of the cathode and surroundings thereof shown in FIG. 3 taken along the VH plane.

FIG. 6 is a cross-sectional view of the cathode and surroundings thereof shown in FIG. 3 taken along the VH plane.

FIG. 7 is a cross-sectional view of a cathode and surroundings thereof in a first embodiment taken along a VH plane.

FIG. 8 is a cross-sectional view of the cathode and surroundings thereof in Variation 1 of the first embodiment taken along a VH plane.

FIG. 9 is a cross-sectional view of the cathode and surroundings thereof in Variation 2 of the first embodiment taken along a VH plane.

FIG. 10 is a cross-sectional view of the cathode and surroundings thereof in Variation 3 of the first embodiment taken along a VH plane.

FIG. 11 is a cross-sectional view of the cathode and surroundings thereof in Variation 4 of the first embodiment taken along a VH plane.

FIG. 12 is an upstream side view of a cathode and a cathode-side sound absorbing member in a second embodiment viewed along an H direction.

FIG. 13 is a cross-sectional view of the cathode and surroundings thereof taken along a line A-A shown in FIG. 12.

FIG. 14 is a cross-sectional view of the cathode and surroundings thereof taken along a line B-B shown in FIG. 12.

FIG. 15 is a cross-sectional view of the cathode and surroundings thereof taken along a line C-C shown in FIG. 12.

FIG. 16 is a cross-sectional view of an anode and surroundings thereof according to a third embodiment taken along a VH plane.

FIG. 17 is a cross-sectional view of an anode and surroundings thereof according to a fourth embodiment taken along a VH plane.

FIG. 18 is a perspective view of an outer electrode of a preliminary ionization electrode in the fourth embodiment.

FIG. 19 is a cross-sectional view of a groove in Variation 1 of the fourth embodiment taken along a VZ plane.

FIG. 20 is a cross-sectional view of the groove and surroundings thereof taken along a line E-E shown in FIG. 19.

FIG. 21 is a cross-sectional view of the groove and surroundings thereof taken along a line F-F shown in FIG. 19.

FIG. 22 is a cross-sectional view of the groove in Variation 2 of the fourth embodiment taken along a VZ plane.

FIG. 23 is a top view of an anode and surroundings thereof in a fifth embodiment.

FIG. 24 is a top view of the anode and surroundings thereof in a variation of the fifth embodiment.

FIG. 25 is a cross-sectional view of a groove and surroundings thereof taken along a line G-G shown in FIG. 24.

FIG. 26 is a cross-sectional view of the groove and surroundings thereof taken along a line H-H shown in FIG. 24.

FIG. 27 is a cross-sectional view of the groove and surroundings thereof taken along a line I-I shown in FIG. 24.

### DETAILED DESCRIPTION

1. Description of electronic device manufacturing apparatus used in electronic device exposure step
2. Description of gas laser apparatus according to Comparative Example
2.1 Configuration
2.2 Operation
2.3 Problems
3. Description of chamber according to first embodiment
3.1 Configuration
3.2 Effects and advantages
4. Description of chamber according to second embodiment
4.1 Configuration
4.2 Effects and advantages
5. Description of chamber according to third embodiment
5.1 Configuration
5.2 Effects and advantages
6. Description of chamber according to fourth embodiment
6.1 Configuration
6.2 Effects and advantages
7. Description of chamber according to fifth embodiment
7.1 Configuration
7.2 Effects and advantages

Embodiments of the present disclosure will be described below in detail with reference to the drawings. The embodiments described below show some examples of the present disclosure and are not intended to limit the contents of the present disclosure. Furthermore, all configurations and operations described in the embodiments are not necessarily essential as configurations and operations in the present disclosure. The same elements have the same reference characters, and no redundant description of the same elements will be made.

### 1. Description of Electronic Device Manufacturing Apparatus Used in Electronic Device Exposure Step

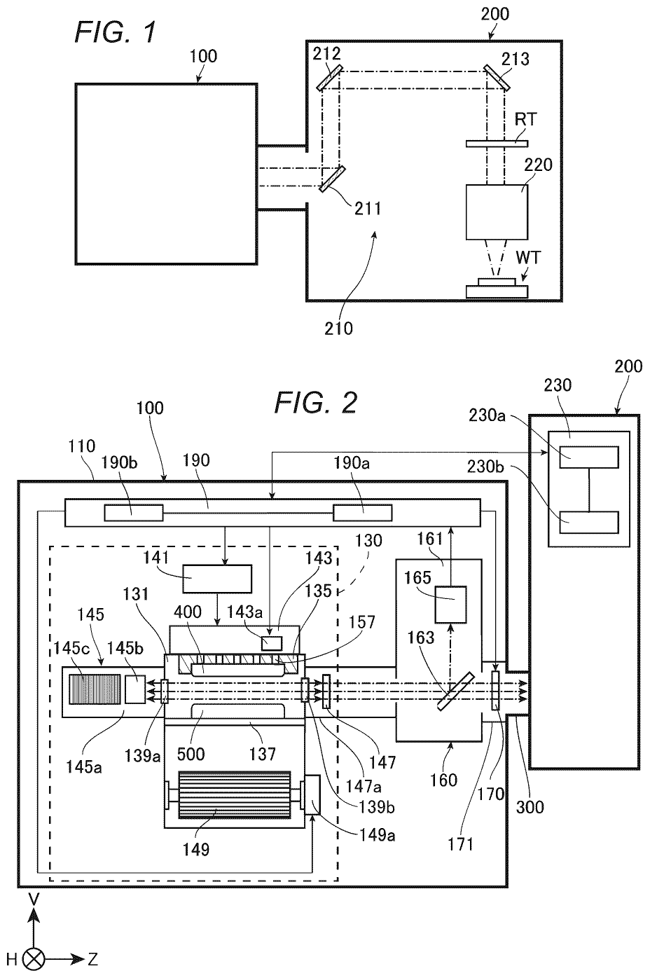

FIG. 1 is a diagrammatic view showing a schematic configuration example of an entire electronic device manufacturing apparatus used in an electronic device exposure step. The manufacturing apparatus used in the exposure step includes a gas laser apparatus 100 and an exposure apparatus 200, as shown in FIG. 1. The exposure apparatus 200 includes an illumination optical system 210, which includes multiple mirrors 211, 212, and 213, and a projection optical system 220. The illumination optical system 210 illuminates a reticle pattern of a reticle that is not shown but is placed on a reticle stage RT with laser light that enters the illumination optical system 210 from the gas laser apparatus 100. The projection optical system 220 performs reduction projection on the laser light having passed through the reticle to bring the laser light into focus on a workpiece that is not shown but is placed on a workpiece table WT. The workpiece is a photosensitive substrate onto which a photoresist has been applied, such as a semiconductor wafer. The exposure apparatus 200 translates the reticle stage RT and the workpiece table WT in synchronization with each other to expose the workpiece to the laser light having reflected the reticle pattern. Semiconductor devices that are electronic devices can be manufactured by transferring a device pattern onto the semiconductor wafer in the exposure step described above.

### 2. Description of Gas Laser Apparatus According to Comparative Example

### 2.1 Configuration

The gas laser apparatus 100 according to Comparative Example will be described. Note that Comparative Example in the present disclosure is a form that the applicant is aware of as known only by the applicant, and is not a publicly known example that the applicant is self-aware of.

FIG. 2 is a diagrammatic view showing a schematic configuration example of the entire gas laser apparatus 100 according to Comparative Example. The gas laser apparatus 100 is, for example, an ArF excimer laser apparatus using a mixture gas containing argon (Ar), fluorine (F₂), and neon (Ne). The gas laser apparatus 100 outputs laser light having a center wavelength of about 193 nm. Note that the gas laser apparatus 100 may instead be a gas laser apparatus other than the ArF excimer laser apparatus, for example, a KrF excimer laser apparatus using a mixture gas containing krypton (Kr), F₂, and Ne. In this case, the gas laser apparatus 100 outputs laser light having a center wavelength of about 248 nm. The mixture gas containing Ar, F₂, and Ne, which are laser media, and the mixture gas containing Kr, F₂, and Ne, which are laser media, are each called a laser gas in some cases.

The gas laser apparatus 100 primarily includes an enclosure 110, a laser oscillator 130, a monitor module 160, a shutter 170, and a laser processor 190, the latter four of which are disposed in the internal space of the enclosure 110.

The laser oscillator 130 includes a chamber 131, a charger 141, a pulse power module 143, a line narrowing module 145, and an output coupling mirror 147. FIG. 2 shows the internal configuration of the chamber 131 viewed in a direction substantially perpendicular to the traveling direction of the laser light.

Examples of the material of the chamber 131 may include metal such as nickel-plated aluminum and nickel-plated stainless steel. The chamber 131 has an internal space in which the laser gas described above is encapsulated and the laser medium in the laser gas is excited to generate light. The light travels to windows 139a and 139b, which will be described later. The laser gas is supplied to the internal space of the chamber 131 from a laser gas supply source that is not shown via a pipe that is not shown. The laser gas in the chamber 131 is caused to flow through a halogen filter that removes the F₂ gas from the laser gas or otherwise processes the laser gas, and the removed F₂ gas is exhausted by an exhaust pump that is not shown out of the enclosure 110 through a pipe that is not shown.

In the internal space of the chamber 131, a cathode 400, which is a first primary electrode, and an anode 500, which is a second primary electrode, are separate from each other and face each other, and the longitudinal direction of each of the electrodes extends along the traveling direction of the laser light. In the following description, the longitudinal direction of the cathode 400 and the anode 500 may be referred to as a Z direction, the direction in which the cathode 400 and the anode 500 are separate from each other and which is perpendicular to the Z direction may be referred to as a V direction, and the direction perpendicular to the V and Z directions may be referred to as an H direction. The cathode 400 and the anode 500 are discharge electrodes that produce glow discharge to excite the laser medium.

The cathode 400 is fixed, for example, via electrically conductive members 157, to a surface of a plate-shaped electrically insulating section 135 that is a surface facing the internal space of the chamber 131. Each electrically conductive member 157 includes a bolt. The electrically conductive members 157 are electrically connected to the pulse power module 143 and apply a high voltage from the pulse power module 143 to the cathode 400. The anode 500 is supported by and electrically connected to a ground plate 137.

The electrically insulating section 135 includes an insulator. Examples of the material of the electrically insulating section 135 may include alumina ceramics, which has low reactivity with F₂ gas. Note that the electrically insulating section 135 only needs to be electrically insulating, and examples of the material of the electrically insulating section 135 may include resin such as phenol resin and fluororesin, quartz, and glass. The electrically insulating section 135 closes an opening provided in the chamber 131 and is fixed to the chamber 131.

The charger 141 is a DC power supply that supplies a predetermined voltage to charge a charging capacitor that is not shown but is provided in the pulse power module 143. The pulse power module 143 includes a switch 143a controlled by the laser processor 190. When the switch 143a is changed from the turned-off state to the turned-on state, the pulse power module 143 generates a high pulse voltage from the electrical energy charged in the charging capacitor and applies the high voltage to the space between the cathode 400 and the anode 500.

When the high voltage is applied to the space between the cathode 400 and the anode 500, discharge occurs therebetween. The energy of the discharge excites the laser medium in the chamber 131, and the excited laser medium emits light when transitioning to the ground state.

The wall surface of the chamber 131 is provided with the pair of windows 139a and 139b. The window 139a is located on one side of the chamber 131 in the traveling direction of the laser light, and the window 139b is located on the other side of the chamber 131 in the traveling direction, so that the windows 139a and 139b sandwich the discharge space between the cathode 400 and the anode 500. The windows 139a and 139b each incline by Brewster's angle with respect to the traveling direction of the laser light so as to suppress reflection of a P-polarized component of the laser light. The laser light as a result of laser oscillation that will be described later exits out of the chamber 131 via the windows 139a and 139b. Since the pulse power module 143 applies the high pulse voltage to the space between the cathode 400 and the anode 500 as described above, the laser light is pulse laser light.

The line narrowing module 145 includes an enclosure 145a, a prism 145b, a grating 145c, and a rotary stage that is not shown, the latter three of which are disposed in the internal space of the enclosure 145a. An opening is formed in the enclosure 145a, and the enclosure 145a is connected to the rear side of the chamber 131 via the opening.

The prism 145b increases the beam width of the light that exits via the window 139a and causes the resultant light to be incident on the grating 145c. Furthermore, the prism 145b reduces the beam width of the light reflected off the grating 145c and causes the resultant light to return into the internal space of the chamber 131 via the window 139a. The prism 145b is supported and rotated by the rotary stage. The rotation of the prism 145b changes the angle of incidence of the light to be incident on the grating 145c. The rotation of the prism 145b therefore allows selection of a wavelength of the light that returns from the grating 145c to the chamber 131 via the prism 145b. FIG. 2 shows an example in which one prism 145b is disposed, and at least one prism only needs to be disposed.

The surface of the grating 145c is made of a high reflectance material, and a large number of grooves are provided at the surface at predetermined intervals. The grooves each have, for example, a right triangular cross-sectional shape. When the light incident from the prism 145b on the grating 145c is reflected off the grooves, the light is diffracted in the direction according to the wavelength of the light. The grating 145c is disposed in the Littrow arrangement, which causes the angle of incidence of the light incident from the prism 145b on the grating 145c to be equal to the angle of diffraction of the diffracted light having a desired wavelength. Light having the desired wavelength and wavelengths arounds thereof thus returns to the chamber 131 via the prism 145b.

The output coupling mirror 147 is disposed in the internal space of an optical path tube 147a connected to the front side of the chamber 131, and faces the window 139b. The output coupling mirror 147 transmits part of the laser light that exits via the window 139b toward the monitor module 160, and reflects the other part of the laser light to cause the reflected light to return into the internal space of the chamber 131 via the window 139b. The grating 145c and the output coupling mirror 147 thus constitute a Fabry-Perot laser resonator, and the chamber 131 is disposed in the optical path of the laser resonator. The light from the chamber 131 travels to the monitor module 160.

The monitor module 160 is disposed in the optical path of the laser light output via the output coupling mirror 147. The monitor module 160 includes an enclosure 161, a beam splitter 163, and a photosensor 165, the latter two of which are disposed in the internal space of the enclosure 161. The enclosure 161 is provided with an opening, and the internal space of the enclosure 161 communicates via the opening with the internal space of the optical path tube 147a.

The beam splitter 163 transmits part of the laser light output via the output coupling mirror 147 toward the shutter 170, and reflects the other part of the laser light toward the light receiving surface of the photosensor 165. The photosensor 165 measures energy E of the laser light incident on the light receiving surface and outputs a signal representing the measured energy E to the laser processor 190.

The laser processor 190 in the present disclosure is a processing apparatus including a storage 190a, which stores a control program, and a CPU (central processing unit) 190b, which executes the control program. The laser processor 190 is particularly configured or programmed to perform various types of processing described in the present disclosure. The laser processor 190 further controls the entire gas laser apparatus 100.

The laser processor 190 transmits and receives various signals to and from an exposure processor 230 of the exposure apparatus 200. For example, the laser processor 190 receives from the exposure processor 230 signals indicating, for example, a light emission trigger Tr and target energy Et, which will be described later. The target energy Et is a target value of the energy of the laser light used in the exposure step. The laser processor 190 controls a charging voltage applied to the charger 141 based on the energy E received from the photosensor 165 and the target energy Et received from the exposure processor 230. Controlling the charging voltage controls the energy of the laser light. The laser processor 190 transmits an instruction signal that turns on or off the switch 143a to the pulse power module 143. Furthermore, the laser processor 190 is electrically connected to the shutter 170 and controls the operation of opening and closing the shutter 170.

The laser processor 190 closes the shutter 170 until a difference ΔE between the energy E received from the monitor module 160 and the target energy Et received from the exposure processor 230 falls within an allowable range. When the difference ΔE falls within the allowable range, the laser processor 190 transmits a reception preparation completion signal indicating that the laser processor 190 is ready to receive the light emission trigger Tr to the exposure processor 230. Upon reception of the reception preparation completion signal, the exposure processor 230 transmits a signal representing the light emission trigger Tr to the laser processor 190, and upon reception of the signal representing the light emission trigger Tr, the laser processor 190 opens the shutter 170. The light emission trigger Tr is a timing signal or an external trigger that is specified by a predetermined repetition frequency f of the laser light and a predetermined number of pulses P thereof, and in response to the light emission trigger Tr, the exposure processor 230 causes the laser oscillator 130 to perform laser oscillation. The repetition frequency f of the laser light is, for example, higher than or equal to 100 Hz but lower than or equal to 10 KHz.

The shutter 170 is disposed in the optical path of the laser light in the internal space of an optical path tube 171, which communicates with an opening formed at an opposite side of the enclosure 161 of the monitor module 160 relative to the side to which the optical path tube 147a is connected. The internal spaces of the optical path tubes 171 and 147a, and the internal spaces of the enclosures 161 and 145a are filled with a purge gas supplied thereto. The purge gas contains an inert gas such as nitrogen (N₂). The purge gas is supplied from a purge gas supply source that is not shown via a pipe that is not shown. The optical path tube 171 communicates with the exposure apparatus 200 through an opening in the enclosure 110 and an optical path tube 300, which connects the enclosure 110 and the exposure apparatus 200 to each other. The laser light having passed through the shutter 170 enters the exposure apparatus 200.

The exposure processor 230 in the present disclosure is a processing apparatus including a storage 230a, which stores a control program, and a CPU 230b, which executes the control program. The exposure processor 230 is particularly configured or programmed to perform various types of processing described in the present disclosure. The exposure processor 230 further controls the entire exposure apparatus 200.

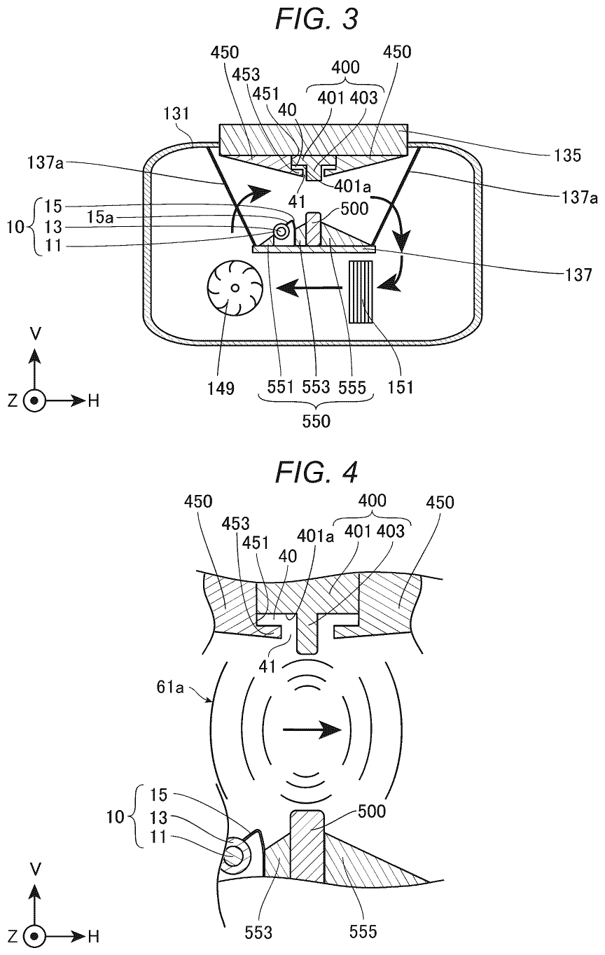

FIG. 3 is a cross-sectional view of the chamber 131 according to Comparative Example taken along a VH plane. A crossflow fan 149 and a heat exchanger 151 are further disposed in the internal space of the chamber 131.

The crossflow fan 149 and the heat exchanger 151 are disposed on the side opposite to the anode 500 with respect to the ground plate 137. In the internal space of the chamber 131, the space where the crossflow fan 149 and the heat exchanger 151 are disposed communicates with the discharge space between the cathode 400 and the anode 500. The heat exchanger 151 is a radiator that is disposed next to the crossflow fan 149 and connected to a pipe which is not shown but through which a cooling medium in the form of liquid or gas flows. The crossflow fan 149 is connected to a motor 149a disposed outside the chamber 131 as shown in FIG. 2, and rotated by the rotation produced by the motor 149a. As the crossflow fan 149 rotates, the laser gas encapsulated in the internal space of the chamber 131 circulates as indicated by the thick-line arrows in FIG. 3. That is, the laser gas circulates through the crossflow fan 149, the discharge space between the cathode 400 and the anode 500, the heat exchanger 151, and the crossflow fan 149 in this order. At least part of the circulating laser gas passes through the heat exchanger 151, which adjusts the temperature of the laser gas. The circulation of the laser gas moves impurities in the laser gas that have been produced by primary discharge between the cathode 400 and the anode 500 downstream, and fresh laser gas is supplied to the discharge space between the cathode 400 and the anode 500 in the next discharge. When the laser gas passes through the heat exchanger 151, the heat produced in association with the primary discharge is removed, and an increase in the temperature of the laser gas is suppressed. Turning on and off the motor 149a and the rotational speed thereof are adjusted under the control of the laser processor 190. The laser processor 190 can therefore adjust the circulation speed of the laser gas circulating in the internal space of the chamber 131 by controlling the motor 149a.

The ground plate 137 is electrically connected to the chamber 131 via wiring 137a. The anode 500 supported by the ground plate 137 is connected to the ground potential via the ground plate 137, the wiring 137a, and the chamber 131.

An anode-side cover 550, which is separate alongside from but covers the anode 500, is disposed on the ground plate 137. The anode-side cover 550 includes cover members 551, 553, and 555, and the cover members 551, 553, and 555 are arranged in this order along the upstream-to-downstream flow of the laser gas. The cover member 551 is fixed to the ground plate 137 with bolts that are not shown, a preliminary ionization electrode 10 is provided between the cover member 551 and the cover member 553, the cover member 553 and the cover member 555 sandwich the anode 500. The anode 500 is fixed to the ground plate 137 with bolts that are not shown, and the cover members 553 and 555 are fixed to the anode 500 with bolts that are not shown. The cover members 551, 553, and 555 may be made, for example, of porous nickel metal that has low reactivity with the F₂ gas. The cover members 551, 553, and 555 guide the laser gas so as to flow from the crossflow fan 149 to the heat exchanger 151 through the discharge space between the cathode 400 and the anode 500 with the air blown by the crossflow fan 149.

The preliminary ionization electrode 10 is provided on the ground plate 137 and alongside the anode 500 in the H direction. The present example shows a case where the preliminary ionization electrode 10 is provided upstream from the anode 500. The preliminary ionization electrode 10 includes a dielectric pipe 11, a preliminary ionization inner electrode, and a preliminary ionization outer electrode. In the following description, the preliminary ionization inner electrode and the preliminary ionization outer electrode are referred to as an inner electrode 13 and an outer electrode 15, respectively, in some cases.

The dielectric pipe 11 is, for example, a cylindrical member and extends along the Z direction. Examples of the material of the dielectric pipe 11 may include alumina ceramics and sapphire.

The inner electrode 13 is a rod-shaped electrode, is disposed in the dielectric pipe 11, and extends along the longitudinal direction of the dielectric pipe 11. Examples of the material of the inner electrode 13 may include copper and brass.

The outer electrode 15 is disposed between the dielectric pipe 11 and the cover member 553, and extends along the longitudinal direction of the dielectric pipe 11. The outer electrode 15 has an end section 15a facing a portion of the outer circumferential surface of the dielectric pipe 11. The end section 15a is provided across the portion from one end to the other end of the outer electrode 15 in the longitudinal direction of the outer electrode 15. The outer electrode 15 is bent in the in-plane direction perpendicular to the longitudinal direction of the dielectric pipe 11, and the bending causes the end section 15a to be in contact with the outer circumferential surface of the dielectric pipe 11 so as to press the outer circumferential surface of the dielectric pipe 11. A portion of the outer circumferential surface of the dielectric pipe 11 that is substantially opposite to a contact portion where the end section 15a of the outer electrode 15 is in contact with the outer circumferential surface is in contact with the cover member 551. Therefore, even when the outer electrode 15 presses the dielectric pipe 11, the dielectric pipe 11 is supported by the cover member 551. Threaded holes that are not shown are provided at an opposite end section of the outer electrode 15 relative to the end section 15a, and the outer electrode 15 is fixed to the cover member 553 with screws that are not shown but are screwed into the threaded holes. It can therefore be understood that the outer electrode 15 is fixed to the anode 500 via the cover member 553. Examples of the material of the outer electrode 15 may include copper and brass.

A pair of cathode-side covers 450 are disposed at the surface of the electrically insulating section 135 that faces the internal space of the chamber 131. The cathode-side covers 450 are disposed at locations upstream and downstream from the cathode 400, extend in the Z direction along the cathode 400, and are separate from each other. The cathode-side covers 450 are each fixed to the electrically insulating section 135 with bolts that are not shown. The cathode-side covers 450 each have a substantially right triangular cross-sectional shape, and have a height that gradually increases in the V direction as approaching the cathode 400 in the H direction. The thus configured cathode-side covers 450 guide the laser gas as the anode-side cover 550 does.

FIG. 4 is a cross-sectional view of the cathode 400 and surroundings thereof shown in FIG. 3 taken along a VH plane. In FIG. 4, the laser gas flowing through the discharge space between the cathode 400 and the anode 500 is indicated by the thick-line arrow. The cathode 400 includes a base 401 fixed to the electrically insulating section 135, and a discharge section 403 protruding from the base 401 toward the anode 500. The base 401 has a rectangular cross-sectional shape elongated in the H direction, and the discharge section 403 has a rectangular cross-sectional shape elongated in the V direction. The base 401 and the discharge section 403 extend along the Z direction and have lengths substantially equal to the length of the cathode 400 in the Z direction. The discharge section 403 is provided at the surface of the base 401 that is opposite to the electrically insulating section 135. The base 401 is wider in the H direction than the discharge section 403, and has surfaces 401a, which are portions of the opposite-side surface described above and are provided on the right and left sides of the discharge section 403 in the H direction. In FIGS. 3 and 4, only the left surface 401a is labeled with the reference character for clarity. The side surfaces of the base 401 that are located in VZ planes are in contact with portions of side surfaces 451 of the cathode-side covers 450, and the side surfaces of the discharge section 403 are not in contact with the side surfaces 451. The discharge section 403 extends toward the anode 500 beyond protrusions 453, which will be described later, of the cathode-side covers 450. Note that FIG. 2 shows the cathode 400 in a simplified manner.

The protrusions 453 of the cathode-side covers 450 protrude in the H direction from the side surfaces 451 of the cathode-side covers 450 toward the side surfaces of the discharge section 403. The protrusions 453 are separate from the discharge section 403 in the H direction and separate from the surfaces 401a, which are portions of the base 401, in the V direction. The protrusions 453 overlap with the surfaces 401a when viewed in the V direction. The protrusions 453 extend in the Z direction and are substantially as long as the cathode 400 in the Z direction. The thus shaped protrusions 453 cover the base 401, and gaps 40 are provided between the protrusions 453 and the base 401. The gaps 40 are each a substantially L-shaped space surrounded by an entrance 41 of the gap 40, which is provided between the side surface of the discharge section 403 and the protrusion 453, the protrusion 453, the side surface 451, the surface 401a, and the side surface of the discharge section 403. The thus formed gaps 40 are provided to avoid failure of the assembly of the cathode 400 and the cathode-side covers 450 due to interference therebetween resulting from manufacturing dimensional errors of the cathode 400 and the cathode-side covers 450. The cathode-side covers 450, which form the gaps 40, laterally cover the cathode 400. Note that since the cathode-side covers 450 are provided at locations upstream and downstream from the cathode 400, the gaps 40 are separately provided at locations upstream and downstream from the cathode 400. The gaps 40 and the cathode-side covers 450 are symmetrically provided at left and right locations in FIG. 3 in the H direction with respect to the discharge section 403. In FIGS. 3 and 4, only the left gap 40 and entrance 41 are labeled with the reference characters for clarity. Acoustic waves 61a shown in FIG. 4 will be described later.

### 2.2 Operation

The operation of the gas laser apparatus 100 according to Comparative Example will next be described.

In the state before the gas laser apparatus 100 outputs the laser light, the internal spaces of the optical path tubes 147a, 171, and 300 and the internal spaces of the enclosures 145a and 161 are filled with the purge gas from the purge gas supply source, which is not shown. The laser gas is supplied from the laser gas supply source, which is not shown, into the internal space of the chamber 131. When the laser gas is supplied, the laser processor 190 controls the motor 149a to cause it to rotate the crossflow fan 149. The rotation of the crossflow fan 149 causes the laser gas to circulate in the interior space of the chamber 131. In this process, the upstream cathode-side cover 450 and the cover members 551 and 553 guide the laser gas from the crossflow fan 149 toward the discharge space between the cathode 400 and the anode 500. Furthermore, the downstream cathode-side cover 450 and the cover member 555 guide the laser gas from the discharge space between the cathode 400 and the anode 500 toward the heat exchanger 151.

Before the gas laser apparatus 100 outputs the laser light, the laser processor 190 receives the signal representing the target energy Et and the signal representing the light emission trigger Tr from the exposure processor 230. The laser processor 190 further turns on the switch 143a of the pulse power module 143. The pulse power module 143 thus applies the high pulse voltage derived from the electrical energy charged in the charging capacitor, which is not shown, to the space between the cathode 400 and the anode 500 and the space between the inner electrode 13 and the outer electrode 15. When the high voltage is applied to the space between the inner electrode 13 and the outer electrode 15, corona discharge occurs in the vicinity of the dielectric pipe 11 and the end section 15a, and radiates ultraviolet light. When the laser gas between the cathode 400 and the anode 500 is irradiated with the ultraviolet light, the laser gas between the cathode 400 and the anode 500 is preliminary ionized. After the preliminary ionization, when the voltage across the space between the cathode 400 and the anode 500 reaches the breakdown voltage, the primary discharge between the cathode 400 and the anode 500 occurs. The laser medium contained in the laser gas between the cathode 400 and the anode 500 thus generates an excimer, which emits light when dissociated. Laser oscillation occurs whenever the light travels back and forth between the grating 145c and the output coupling mirror 147 and passes through the discharge space in the internal space of the chamber 131 so that the light is amplified. Part of the laser light then passes as the pulse laser light through the output coupling mirror 147 and travels to the beam splitter 163.

Part of the laser light having traveled to the beam splitter 163 is reflected off the beam splitter 163 and received by the photosensor 165. The photosensor 165 measures the energy E of the received laser light and outputs the signal representing the energy E to the laser processor 190. The laser processor 190 controls the charging voltage in such a way that the difference ΔE between the energy E and the target energy Et falls within the allowable range. Another part of the laser light having traveled to the beam splitter 163 passes through the beam splitter 163 and passes through the shutter 170, and travels to the exposure apparatus 200.

### 2.3 Problems

In the gas laser apparatus 100 according to Comparative Example, the primary discharge between the cathode 400 and the anode 500 produces a high-temperature, high-pressure state in the discharge space between the cathode 400 and the anode 500 in an extremely short period. The acoustic waves 61a, which are indicated in FIG. 4 by solid-line curves that mimic the acoustic waves 61a, are generated in the discharge space. The acoustic waves 61a are compressional waves of the laser gas in the chamber 131, and propagate from the discharge space while spreading in the chamber 131. The propagation speed of the acoustic waves 61a is approximately 500 m/s.

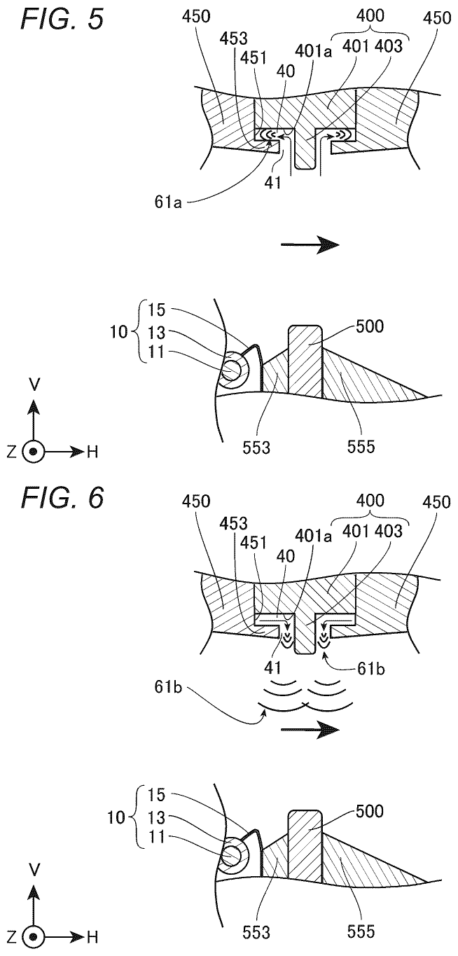

FIGS. 5 and 6 are cross-sectional views of the cathode 400 and surroundings thereof taken along a VH plane, like FIG. 4. The acoustic waves 61a may propagate away from the discharge space via the entrances 41 of the gaps 40 into the gaps 40, as shown in FIG. 5. The acoustic waves 61a having propagated into the gaps 40 may be reflected off the cathode 400 and the cathode-side covers 450 around the gaps 40, and may return to the discharge space as reflected waves 61b indicated by solid-line curves as shown in FIG. 6. In FIGS. 5 and 6, the traveling directions of the acoustic waves 61a and the reflected waves 61b are indicated by the thin-line arrows.

When the reflected waves 61b return to the discharge space at the timing when the primary discharge occurs, the reflected waves 61b change the density distribution of the laser gas in the discharge space to make the primary discharge unstable, so that the stability of the energy of the laser light output from the gas laser apparatus 100 may deteriorate. The reflected waves 61b may thus affect the performance of the laser light. The degree of the effect described above tends to increase when the repetition frequency of the laser light is higher than or equal to 2 kHz. The gas laser apparatus 100 therefore does not output laser light that satisfies the performance required by the exposure apparatus 200, and there is a concern about deterioration in the reliability of the gas laser apparatus 100.

Therefore, the following embodiments show examples of the chamber 131 of the gas laser apparatus 100 that can suppress the decrease in the reliability thereof.

### 3. Description of Chamber According to First Embodiment

The chamber 131 according to a first embodiment will next be described. Note that the same configurations as those described above have the same reference characters, and duplicate description of the same configurations will be omitted unless otherwise particularly described. In addition, in some of the drawings, some of the members are omitted or simplified in some cases for clarity, only some of the same elements have the same reference characters, and some other elements do not have reference characters in some cases.

### 3.1 Configuration

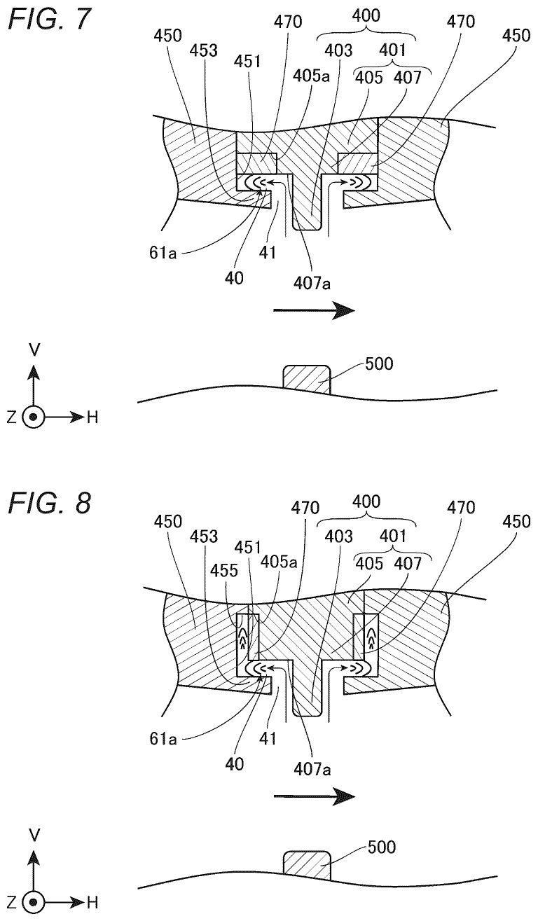

FIG. 7 is a cross-sectional view of the cathode 400 and surroundings thereof in the present embodiment taken along a VH plane. In the chamber 131 according to the present embodiment, the base 401 differs from the base 401 in Comparative Example in configuration. Furthermore, the chamber 131 according to the present embodiment differs from the chamber 131 according to Comparative Example in that the former further includes cathode-side sound absorbing members 470 provided in the gaps 40 at locations upstream and downstream from the cathode 400.

The base 401 in the present embodiment includes a first base 405 and a second base 407. The second base 407 is provided at the surface of the first base 405 that is opposite to the electrically insulating section 135. The second base 407 protrudes from the first base 405 toward the anode 500. The first base 405 is wider in the H direction than the second base 407, and has surfaces 405a, which are portions of the aforementioned opposite-side surface of the first base 405 and are provided on the right and left sides of the second base 407 in the H direction. The discharge section 403 is provided at the surface of the second base 407 that is opposite to the first base 405. The discharge section 403 protrudes from the second base 407 toward the anode 500. The second base 407 is wider in the H direction than the discharge section 403, and has surfaces 407a, which are portions of the aforementioned opposite-side surface of the second base 407 and are provided on the right and left sides of the discharge section 403 in the H direction. The surfaces 407a face the entrances 41. In FIG. 7, only the left surfaces 405a and 407a are labeled with the reference characters for clarity. The first base 405 is in contact with portions of the side surfaces 451 of the cathode-side covers 450, and the second base 407 is not in contact with the side surfaces 451. That is, the cathode-side covers 450 are separate from the second base 407, which is a portion of the base 401. The first base 405 and the second base 407 are disposed closer to the electrically insulating section 135 than the entrances 41.

The cathode-side sound absorbing members 470 in the present embodiment are disposed at the base 401, specifically, at the surfaces 405a of the first base 405, and fastened to the first base 405 with screws. The cathode-side sound absorbing members 470 are provided in the gaps 40 between the second base 407, which is a portion of the base 401, and the side surfaces 451 of the cathode-side covers 450, are in contact with the side surfaces of the second base 407, and face portions of the protrusions 453 and portions of the entrances 41 of the gaps 40. Since the cathode-side sound absorbing members 470 are also in contact with the side surfaces 451 of the cathode-side covers 450, it can be understood that the cathode-side sound absorbing members are also disposed in the gaps 40 at the positions farthest from the discharge space. The regions of the gaps 40 in the present embodiment into which the acoustic waves 61a propagate are each the space surrounded by the entrance 41, the protrusion 453, the side surface 451, the surface 405a, the side surface of the second base 407, the surface 407a, and the side surface of the discharge section 403. The thus configured gaps 40 each include the entrance 41, a first space communicating with the entrance 41 and having a rectangular shape longer in the H direction than in the V direction, and a second space communicating with the first space, located deeper than the first space, and having a rectangular shape longer in the H direction than in the V direction and narrower than the first space in the H direction. The cathode-side sound absorbing members 470 extend along the Z direction and are substantially as long as the cathode 400, but may be shorter than the cathode 400.

The cathode-side sound absorbing members 470 are each configured, for example, with a porous member. Examples of the material of the cathode-side sound absorbing members 470 may include nickel, copper, iron, stainless steel, brass, and other metals. The cathode-side sound absorbing members 470 may each be any electrical insulator as long as being configured with a porous member, and the material of the cathode-side sound absorbing members 470 may, for example, be alumina ceramics.

### 3.2 Effects and Advantages

When a voltage is applied to the space between the cathode 400 and the anode 500 so that the primary discharge occurs between the cathode 400 and the anode 500, light is emitted from the laser gas, and the light passes through the window 139b and exits out of the chamber 131. Also in the chamber 131 according to the present embodiment, the primary discharge generates the acoustic waves 61a in the discharge space between the cathode 400 and the anode 500, and the acoustic waves 61a may propagate into the gaps 40 between the base 401 and the cathode-side covers 450. The acoustic waves 61a having propagated into the gaps 40 are absorbed by the cathode-side sound absorbing members 470 provided in the gaps 40. The absorbed acoustic waves 61a propagate through the interior of the cathode-side sound absorbing members 470 while repeatedly reflected therein, are converted, for example, into thermal energy, and gradually attenuated. The acoustic waves 61a having passed through the cathode-side sound absorbing members 470 are reflected off the base 401 and the cathode-side covers 450 around the cathode-side sound absorbing members 470, and are absorbed again by the cathode-side sound absorbing members 470. The absorbed acoustic waves 61a are repeatedly reflected in the cathode-side sound absorbing members 470 as described above and further attenuated. The reflected waves 61b, which are the acoustic waves 61a reflected in the cathode-side sound absorbing members 470 and returning to the discharge space, are thus reduced in magnitude, so that a change due to the reflected waves 61b in the density distribution of the laser gas in the discharge space can be suppressed, so that the unstable primary discharge can be suppressed. FIG. 7 does not show the reflected waves 61b for clarity. The cathode-side covers 450 cover the base 401, so that unnecessary discharge from the base 401 can be suppressed during the primary discharge. The deterioration in the stability of the energy of the laser light output from the gas laser apparatus 100 can thus be suppressed. The gas laser apparatus 100 can therefore output laser light that satisfies the performance required by the exposure apparatus 200, so that deterioration in the reliability of the gas laser apparatus 100 can be suppressed.

In the chamber 131 according to the present embodiment, the cathode-side sound absorbing members 470 are disposed in the gaps 40 also at the positions farthest from the discharge space between the cathode 400 and the anode 500.

The acoustic waves 61a, which propagate to the positions farthest from the discharge space while being absorbed by the cathode-side sound absorbing members 470, tend to attenuate. The configuration described above can therefore attenuate the acoustic waves 61a propagating to the positions farthest from the discharge space and the reflected waves 61b returning from the cathode-side sound absorbing members 470 to the discharge space. The change due to the reflected waves 61b in the density distribution of the laser gas in the discharge space can thus be suppressed, so that the unstable primary discharge can be suppressed.

The cathode-side sound absorbing members 470 in the present embodiment are disposed at the surfaces 405a of the first base 405, and may instead be disposed at the surfaces 405a and/or the surfaces 407a of the second base 407, or may still instead be disposed so as to fill the entire gaps 40. The cathode-side sound absorbing members 470 are disposed in the gaps 40 at locations upstream and downstream from the cathode 400, and may instead be disposed in at least one of the gaps 40. Still instead, the cathode-side sound absorbing members 470 may be disposed so as to surround the entire circumference of the cathode 400 including the first base 405 and the second base 407.

The positions where the cathode-side sound absorbing members 470 are disposed are not necessarily limited to the positions described above, and other examples of the positions will be described with reference to variations.

FIG. 8 is a cross-sectional view of the cathode 400 and surroundings thereof in Variation 1 of the present embodiment taken along a VH plane. The chamber 131 according to the present variation differs from the chamber 131 according to the present embodiment in that the cathode-side sound absorbing members 470 are separate from the side surfaces 451 of the cathode-side covers 450. The regions of the gaps 40 in the present variation into which the acoustic waves 61a propagate are each the space surrounded by the entrance 41, the protrusion 453, the side surface 451, a surface 455 of the cathode-side cover 450, which faces the protrusion 453, the surface 405a, the side surface of the second base 407, the surface 407a, and the side surface of the discharge section 403. The thus configured gaps 40 each include the entrance 41, a first space communicating with the entrance 41 and having a rectangular shape longer in the H direction than in the V direction, and a second space communicating with the first space, located deeper than the first space, and having a rectangular shape longer in the V direction than in the H direction and narrower than the first space in the H direction, so that the gaps 40 each have the shape of a crank.

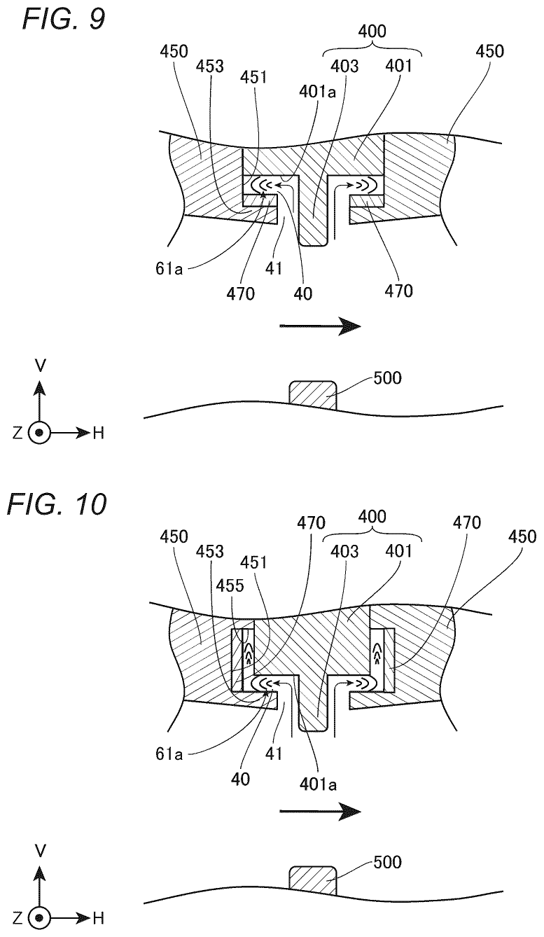

FIG. 9 is a cross-sectional view of the cathode 400 and surroundings thereof in Variation 2 of the present embodiment taken along a VH plane. The base 401 in the present variation is configured in the same manner as the base 401 in Comparative Example. The chamber 131 according to the present variation differs from the chamber 131 in the present embodiment in that the cathode-side sound absorbing members 470 are disposed at the cathode-side covers 450. Specifically, the cathode-side sound absorbing members 470 are disposed at the surfaces of the protrusions 453 that face the surfaces 401a of the base 401. That is, the cathode-side sound absorbing members 470 are each provided in the gap between the surface 401a, which is a portion of the base 401, and the protrusion 453 of the cathode-side cover 450. The cathode-side sound absorbing members 470 are fastened to the protrusions 453 with screws, are in contact with the side surfaces 451 of the cathode-side covers 450, and are separate from and face the surfaces 401a.

FIG. 10 is a cross-sectional view of the cathode 400 in Variation 3 of the present embodiment and surroundings thereof taken along a VH plane. The chamber 131 according to the present variation differs from the chamber 131 in Variation 2 in that the cathode-side sound absorbing members 470 are disposed at the side surfaces 451 of the cathode-side covers 450. The cathode-side sound absorbing members 470 are fastened to the side surfaces 451 with screws. The cathode-side sound absorbing members 470 are separate from the side surfaces of the base 401 and are in contact with portions of the surfaces 455 of the cathode-side covers 450 and portions of the protrusions 453. Since the cathode-side sound absorbing members 470 are also in contact with the corners between the side surfaces 451 and the surfaces 455, it can be understood that the cathode-side sound absorbing members are disposed in the gaps 40 at the positions farthest from the discharge space. The regions of the gaps 40 in the present variation into which the acoustic waves 61a propagate are each the space surrounded by the entrance 41 of the gap 40, the protrusion 453, the side surface 451, the surface 455, the side surface of the base 401, the surface 401a of the base 401, and the side surface of the discharge section 403. The thus configured gaps 40 each include the entrance 41, the first space, and the second space, so that the gaps 40 each have the shape of a crank, as in Variation 1. Note that the side surfaces 451 of the cathode-side covers 450 are separate from portions of the side surfaces of the base 401 but are in contact with other portions of the side surfaces of the base 401.

In any of Variations 1, 2, and 3, the acoustic waves 61a having propagated into the gaps 40 are absorbed by the cathode-side sound absorbing members 470. The magnitude of the reflected waves 61b is therefore reduced, so that the deterioration in the stability of the energy of the laser light output from the gas laser apparatus 100 can be suppressed.

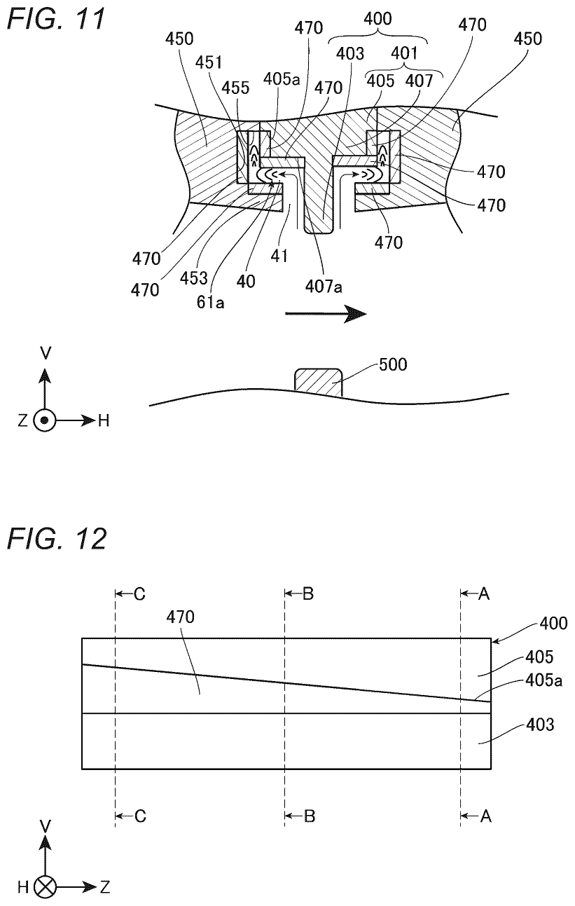

FIG. 11 is a cross-sectional view of the cathode 400 and surroundings thereof in Variation 4 of the present embodiment taken along a VH plane. In the chamber 131 according to the present variation, the base 401 includes the first base 405 and the second base 407 as the base 401 in the present embodiment, Variations 1 to 3 are combined with one another, and the cathode-side sound absorbing members 470 are also disposed at the surfaces 407a of the second base 407. That is, in the chamber 131 according to the present variation, the cathode-side sound absorbing members 470 are disposed at the surfaces 405a, the surfaces 407a, the protrusions 453, and the side surfaces 451. The cathode-side sound absorbing members 470 disposed at the surfaces 407a extend in the H direction, and are disposed at the cathode-side sound absorbing members 470 disposed at the surfaces 405a. The cathode-side sound absorbing members 470 disposed at the protrusions 453 face and are separate from the cathode-side sound absorbing members 470 disposed at the surfaces 407a of the second base 407. The cathode-side sound absorbing members 470 disposed at the side surfaces 451 of the cathode-side covers 450 face and are separate from the cathode-side sound absorbing members 470 disposed at the surfaces 405a of the first base 405 and the surfaces 407a of the second base 407.

According to the configuration described above, the acoustic waves 61a can be absorbed by the cathode-side sound absorbing members 470 and attenuated by a greater amount than the case where the cathode-side sound absorbing members 470 are disposed only at the base 401 or the cathode-side covers 450. The magnitude of the reflected waves 61b is therefore further reduced, so that the deterioration in the stability of the energy of the laser light output from the gas laser apparatus 100 can be further suppressed.

### 4. Description of Chamber According to Second Embodiment

The chamber 131 according to a second embodiment will next be described. Note that the same configurations as those described above have the same reference characters, and duplicate description of the same configurations will be omitted unless otherwise particularly described. In addition, in some of the drawings, some of the members are omitted or simplified in some cases for clarity, only some of the same elements have the same reference characters, and some other elements do not have reference characters in some cases.

### 4.1 Configuration

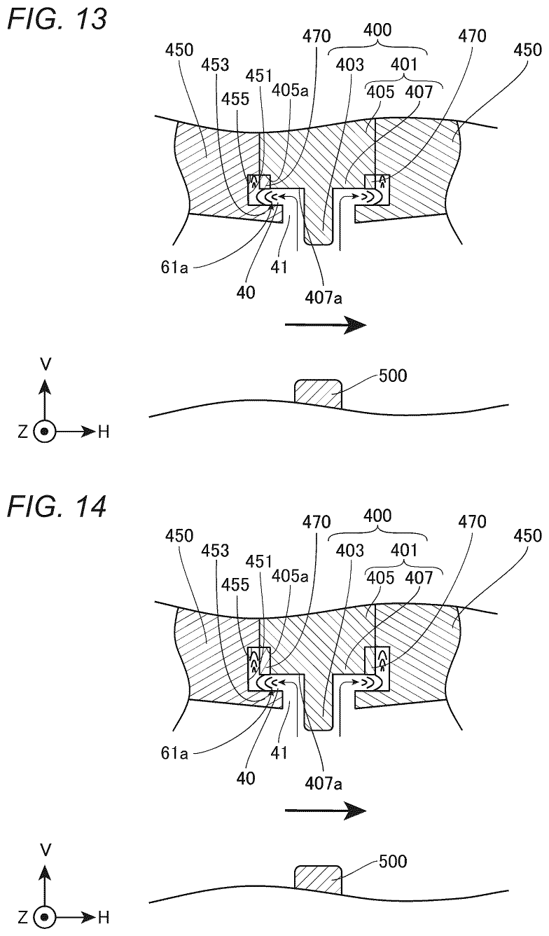

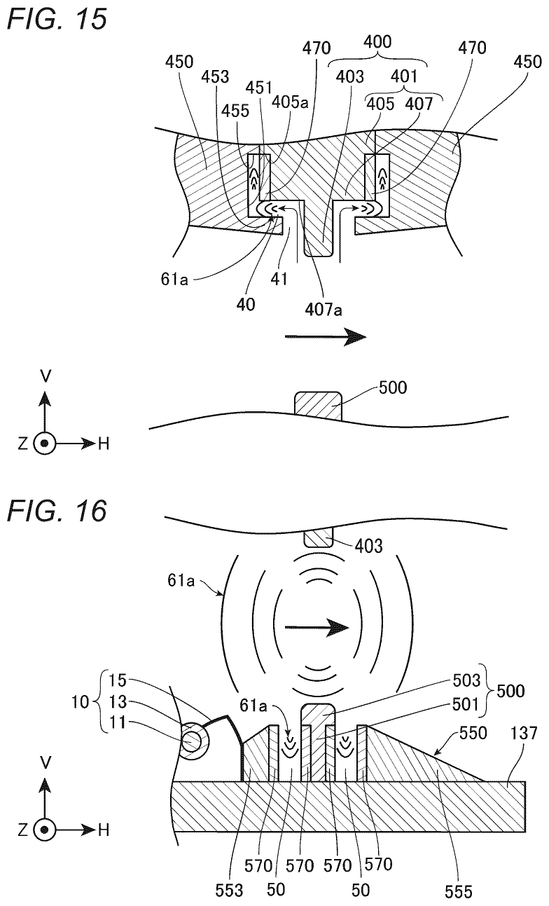

FIG. 12 is an upstream side view of the cathode 400 and one of the cathode-side sound absorbing members 470 in the present embodiment viewed along the H direction. FIG. 13 is a cross-sectional view of the cathode 400 and surroundings thereof taken along a line A-A shown in FIG. 12, FIG. 14 is a cross-sectional view of the cathode 400 and surroundings thereof taken along a line B-B shown in FIG. 12, and FIG. 15 is a cross-sectional view of the cathode 400 and surroundings thereof taken along a line C-C shown in FIG. 12.

The cathode-side sound absorbing members 470 in the present embodiment are disposed at the surfaces 405a of the first base 405 and are separate from the side surfaces 451 of the cathode-side covers 450 as in Variation 1 of the first embodiment. In the chamber 131 according to the present embodiment, however, the surfaces 405a, the surfaces 455 of the cathode-side covers 450 that are in contact with the gaps 40, and the cathode-side sound absorbing members 470 are configured differently from those in Variation 1 of the first embodiment.

The surfaces 405a of the first base 405 and the surfaces 455 of the cathode-side covers 450 gradually incline away from the anode 500 and the protrusions 453 as the surfaces extend from one side toward the other side in the Z direction. The one side in the Z direction is closer to the monitor module 160 than the other side in the Z direction is to the monitor module 160, and the other side in the Z direction is closer to the line narrowing module 145 than the one side in the Z direction is to the line narrowing module 145. The region of each of the gaps 40 between the side surface of the second base 407 and the side surface 451 of the cathode-side cover 450 therefore gradually becomes deeper in the V direction as the region extends from the one side toward the other side in the Z direction.

The cathode-side sound absorbing members 470 are disposed at the surfaces 405a inclining as described above. The cathode-side sound absorbing members 470 in the present embodiment are so configured that the height thereof in the V direction gradually increases as the cathode-side sound absorbing members 470 extend from the one side toward the other side in the Z direction. The surfaces of the cathode-side sound absorbing members 470 that face the protrusions 453 remain at the same height as the surfaces extend from the one side toward the other side in the Z direction, and are flush with the surfaces 407a of the second base 407. The side surfaces of the second base 407 are therefore covered with the cathode-side sound absorbing members 470.

### 4.2 Effects and Advantages

In the chamber 131 according to the present embodiment, the surfaces 455 of the cathode-side covers 450 that are in contact with the gaps 40 extend in the Z direction, which is a predetermined direction and perpendicular to the V direction from the anode 500 toward the cathode 400, and incline away from the anode 500 as the surfaces 455 extend from the one side toward the other side in the Z direction.

According to the configuration described above, the distance from the surface 455 on the other side in the Z direction to the discharge space is longer than the distance from the surface 455 on the one side in the Z direction to the discharge space. Therefore, when the acoustic waves 61a having propagated into the gaps 40 are reflected off the surfaces 455, phase shift occurs between the reflected waves 61b returning from the surfaces 455 on the other side in the Z direction to the discharge space and the reflected waves 61b returning from the surfaces 455 on the one side in the Z direction to the discharge space. The phase shift may prevent all the reflected waves 61b from returning to the discharge space at the same time unlike the case where no phase shift occurs. The change due to the reflected waves 61b in the density distribution of the laser gas in the discharge space can therefore be suppressed, so that the unstable primary discharge can be suppressed.

The cathode-side sound absorbing members 470 in the present embodiment extend in the Z direction and are disposed at the base 401. The height of the cathode-side sound absorbing members 470 in the V direction from the anode 500 toward the cathode 400 gradually increases as the cathode-side sound absorbing members 470 extend from the one side toward the other side in the Z direction.

According to the configuration described above, the acoustic waves 61a absorbed by the cathode-side sound absorbing members 470 are attenuated because the acoustic waves 61a are repeatedly reflected in the cathode-side sound absorbing members 470 a larger number of times on the other side than on the one side in the Z direction. The reflected waves 61b returning from the other side in the Z direction to the discharge space may therefore be attenuated by a greater amount than the reflected waves 61b returning from the one side in the Z direction to the discharge space, so that the change due to the reflected waves 61b in the density distribution of the laser gas in the discharge space may be suppressed as compared with a case where no attenuation occurs, and the unstable primary discharge may therefore be suppressed.

The chamber 131 according to the present embodiment has been described with reference to Variation 1 of the first embodiment, but is not necessarily used therein and may be used in the first embodiment or the other variations of the first embodiment. That is, the cathode-side sound absorbing members 470 may be disposed at surfaces perpendicular to the V direction from the anode 500 toward the cathode 400. Examples of the surfaces may include the surfaces 405a in the first embodiment, the surfaces of the protrusions 453 in Variation 2 that face the surfaces 401a of the base 401, and the surfaces 455 of the cathode-side covers 450 in Variation 3. These surfaces may each incline away from the anode 500 as the surface extends from the one side toward the other side in the Z direction.

The chamber 131 according to the present embodiment has been described on the assumption that the one side of the chamber 131 in the Z direction is closer to the monitor module 160 than the other side of the chamber 131 in the Z direction is to the monitor module 160, and that the other side of the chamber 131 in the Z direction is closer to the line narrowing module 145 than the one side of the chamber 131 in the Z direction is to the line narrowing module 145, but the two sides may be swapped. That is, the one side in the Z direction may be closer to the line narrowing module 145 than the other side in the Z direction to the line narrowing module 145, and the other side in the Z direction may be closer to the monitor module 160 than the one side in the Z direction is to the monitor module 160.

The height of the cathode-side sound absorbing members 470 does not need to gradually increase in the V direction as the cathode-side sound absorbing members 470 extend from the one side toward the other side in the Z direction. The height of the cathode-side sound absorbing members 470 may increase stepwise as they extend from the one side toward the other side in the Z direction.

### 5. Description of Chamber According to Third Embodiment

The chamber 131 according to a third embodiment will next be described. Note that the same configurations as those described above have the same reference characters, and duplicate description of the same configurations will be omitted unless otherwise particularly described. In addition, in some of the drawings, some of the members are omitted or simplified in some cases for clarity, only some of the same elements have the same reference characters, and some other elements do not have reference characters in some cases.

Note that the chamber 131 according to the third embodiment, the following embodiments, and variations thereof will be described with reference primarily to the configurations of the anode 500 and surroundings thereof, and the configurations of the cathode 400 and surroundings thereof may be the same as those of the cathode 400 and surroundings thereof in any of the first and second embodiments and the variations thereof.

### 5.1 Configuration

FIG. 16 is a cross-sectional view of the anode 500 and surroundings thereof according to the present embodiment taken along a VH plane. The chamber 131 according to the present embodiment differs from the chamber 131 according to the first embodiment in that the anode 500 includes a base 501 and a discharge section 503 extending in the Z direction, and the anode-side cover 550 is separate alongside from but covers the anode 500.

The base 501 is fixed to the ground plate 137, and the discharge section 503 protrudes from the base 501 toward the discharge section 403 of the cathode 400. Unlike the cathode 400, the base 501 is narrower in the H direction than the discharge section 503, and the side surfaces of the base 501 are located inside the side surfaces of the discharge section 503.

The anode-side cover 550, which includes the cover members 553 and 555 separate from the anode 500, has gaps 50 provided between the anode 500 and the cover member 553 and between the anode 500 and the cover member 555.

The chamber 131 according to the present embodiment differs from the chamber 131 according to the first embodiment in that the former further includes anode-side sound absorbing members 570 provided in the gaps 50 between the anode-side cover 550 and the anode 500. The anode-side sound absorbing members 570 are disposed at the side surfaces of the cover members 553 and 555 that face the anode 500, and are fastened to the side surfaces with screws. The anode-side sound absorbing members 570 are also disposed at the upstream side surface and the downstream side surface of the base 501 of the anode 500, and are fastened to the side surfaces of the base 501 with screws. The four anode-side sound absorbing members 570 are therefore disposed at the anode-side cover 550 and the anode 500. The anode-side sound absorbing members 570 disposed at the cover member 553 and the upstream side surface of the base 501 face each other, and the anode-side sound absorbing members 570 disposed at the downstream side surface of the base 501 and the cover member 555 face each other. The anode-side sound absorbing members 570 extend along the Z direction and are substantially as long as the anode 500, but may be shorter than the anode 500. The configuration and material of the anode-side sound absorbing members 570 are the same as the configuration and material of the cathode-side sound absorbing members 470.

### 5.2 Effects and Advantages

The acoustic waves 61a also propagate from the discharge space between the cathode 400 and the anode 500 into the gaps 50 between the anode 500 and the anode-side cover 550. In the configuration described above, since the anode-side sound absorbing members 570 are also disposed in the gaps 50, the acoustic waves 61a having propagated into the gaps 50 can be absorbed by the anode-side sound absorbing members 570 provided in the gaps 50 and gradually attenuated. The magnitude of the reflected waves 61b reflected in the anode-side sound absorbing members 570 and returning to the discharge space is therefore reduced, so that the change due to the reflected waves 61b in the density distribution of the laser gas in the discharge space can be suppressed, and the unstable primary discharge may therefore be suppressed. The deterioration in the stability of the energy of the laser light output from the gas laser apparatus 100 can thus be suppressed. FIG. 16 does not show the reflected waves 61b for clarity.

In the chamber 131 according to the present embodiment, the anode-side sound absorbing members 570 are disposed at the anode-side cover 550 and the anode 500.

According to the configuration described above, the acoustic waves 61a can be absorbed and attenuated by the anode-side sound absorbing members 570 by a greater amount than the case where the anode-side sound absorbing members 570 are disposed only at the anode 500 or the anode-side cover 550. The magnitude of the reflected waves 61b is therefore further reduced, so that the deterioration in the stability of the energy of the laser light output from the gas laser apparatus 100 can be further suppressed.

In the chamber 131 according to the present embodiment, the anode-side sound absorbing members 570 are disposed at the anode-side cover 550 and the anode 500, and may instead be disposed at the anode-side cover 550 or the anode 500. The side surfaces of the base 501 may not be located inside the side surfaces of the discharge section 503 but may coincide with the side surfaces of the discharge section 503, that is, the anode 500 may be configured in the same manner as the anode 500 in Comparative Example, and the anode-side sound absorbing members 570 may be disposed at the side surfaces of the anode 500.

### 6. Description of Chamber According to Fourth Embodiment

The chamber 131 according to a fourth embodiment will next be described. Note that the same configurations as those described above have the same reference characters, and duplicate description of the same configurations will be omitted unless otherwise particularly described. In addition, in some of the drawings, some of the members are omitted or simplified in some cases for clarity, only some of the same elements have the same reference characters, and some other elements do not have reference characters in some cases.

### 6.1 Configuration

FIG. 17 is a cross-sectional view of the anode 500 and surroundings thereof according to the present embodiment taken along a VH plane. The chamber 131 according to the present embodiment differs from the chamber 131 according to the first embodiment in that a groove 137b is provided in the ground plate 137 and the anode-side sound absorbing member 570 is disposed in the groove 137b.

The groove 137b is provided upstream from and alongside the anode 500, specifically, between the cover member 551 and the cover member 553, and below the dielectric pipe 11 and the outer electrode 15. The groove 137b extends in the Z direction, and the depth of the groove 137b in the V direction is fixed in the Z direction.

The height of the anode-side sound absorbing member 570 in the V direction, which is disposed in the groove 137b described above, is fixed in the Z direction, and the anode-side sound absorbing member 570 faces the dielectric pipe 11 and the outer electrode 15. The anode-side sound absorbing member 570 does not protrude beyond the principal surface of the ground plate 137, and a surface 570a of the anode-side sound absorbing member 570 that faces the dielectric pipe 11 and the outer electrode 15 is flush with the principal surface of the ground plate 137.

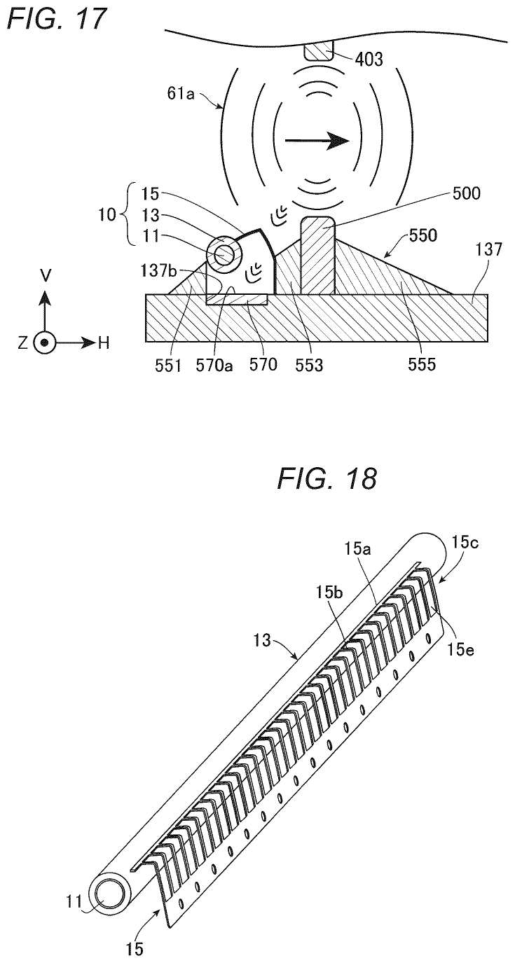

FIG. 18 is a perspective view of the outer electrode 15 of the preliminary ionization electrode 10 in the present embodiment. The outer electrode 15 includes the end section 15a, which extends along the longitudinal direction of the dielectric pipe 11, which is the Z direction, and is in contact with the outer circumferential surface of the dielectric pipe 11, and a rudder section 15c, which includes multiple bar members 15b each having one end connected to the end section 15a and arranged side by side along the longitudinal direction of the end section 15a. The outer electrode 15 having gaps 15e between the multiple bar members 15b does not isolate the discharge space from the anode-side sound absorbing member 570, and the acoustic waves 61a propagate from the discharge space to the anode-side sound absorbing member 570 through the gaps 15e, as shown in FIG. 17.

### 6.2 Effects and Advantages

The acoustic waves 61a also propagate from the discharge space between the cathode 400 and the anode 500 to the ground plate 137 via the gaps 15e between the multiple bar members 15b. In the configuration described above, since the anode-side sound absorbing member 570 is disposed in the groove 137b of the ground plate 137, the acoustic waves 61a can be absorbed by the anode-side sound absorbing member 570. The magnitude of the reflected waves 61b returning from the anode-side sound absorbing member 570 and the groove 137b to the discharge space is therefore reduced, so that the change due to the reflected waves 61b in the density distribution of the laser gas in the discharge space can be suppressed, and the unstable primary discharge may therefore be suppressed. The deterioration in the stability of the energy of the laser light output from the gas laser apparatus 100 can thus be suppressed. Furthermore, since the anode-side sound absorbing member 570 is disposed in the groove 137b, the degree by which the anode-side sound absorbing member 570 inhibits the flow of the laser gas in the chamber 131 can be suppressed as compared with a case where the anode-side sound absorbing member 570 is disposed at the principal surface of the ground plate 137.

Note that the groove 137b and the anode-side sound absorbing member 570 are not necessarily configured as described above, and other examples of the configurations of the groove 137b and the anode-side sound absorbing member 570 will be described with reference to variations.

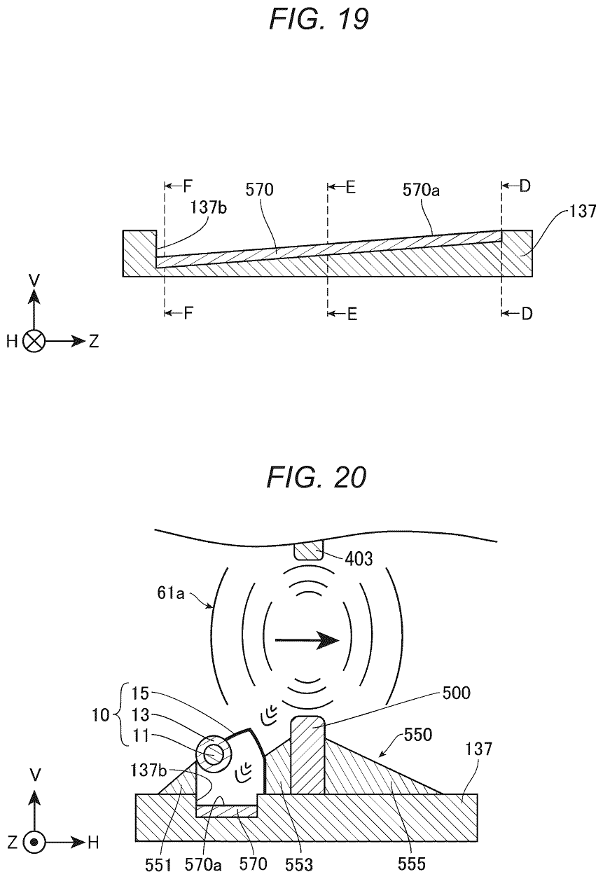

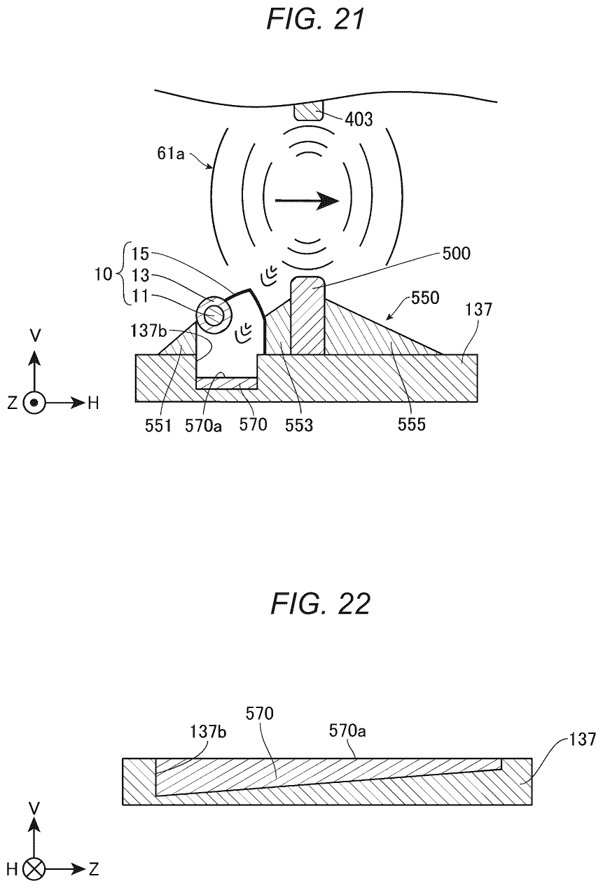

FIG. 19 is a cross-sectional view of the groove 137b in Variation 1 of the present embodiment taken in a VZ plane. FIG. 19 does not show those other than the ground plate 137, the groove 137b, and the anode-side sound absorbing member 570 for clarity. FIG. 20 is a cross-sectional view of the groove 137b and surroundings thereof taken along a line E-E shown in FIG. 19, and FIG. 21 is a cross-sectional view of the groove 137b and surroundings thereof taken along a line F-F shown in FIG. 19. Note that the cross-sectional view of the groove 137b and surroundings thereof taken along a line D-D shown in FIG. 19 is the same as the cross-sectional view of FIG. 17.

The groove 137b in the present variation differs from the groove 137b in the embodiment in that the depth of the groove 137b in the V direction, which is perpendicular to the Z direction and perpendicular to the principal surface of the ground plate 137, gradually increases as the groove 137b extends from one side toward the other side in the Z direction. The bottom surface of the groove 137b therefore inclines as the groove 137b extends from the one side toward the other side in the Z direction. The one side in the Z direction is closer to the monitor module 160 than the other side in the Z direction is to the monitor module 160, and the other side in the Z direction is closer to the line narrowing module 145 than the one side in the Z direction is to the line narrowing module 145.

The anode-side sound absorbing member 570 in the present variation is disposed at the bottom surface of the groove 137b inclining as described above, and the height of the anode-side sound absorbing member 570 in the V direction is fixed across the anode-side sound absorbing member 570 from the one side toward the other side in the Z direction, as in the fourth embodiment. Therefore, at the position of the line D-D, the anode-side sound absorbing member 570 does not protrude beyond the principal surface of the ground plate 137, and the surface 570a of the anode-side sound absorbing member 570 is flush with the principal surface of the ground plate 137, as in the fourth embodiment. The surface 570a is located at a position lower than the principal surface of the ground plate 137 at the position of the line E-E, and is located at a position further lower than the principal surface of the ground plate 137 at the position of the line F-F.

The depth of the groove 137b in the present variation in the V direction, which is perpendicular to the Z direction, which is the predetermined direction, and which is perpendicular to the principal surface of the ground plate 137, gradually increases as the groove 137b extends from one side toward the other side in the predetermined direction.

According to the configuration described above, the distance from the bottom surface of the groove 137b on the other side in the predetermined direction to the discharge space is longer than the distance from the bottom surface on the one side in the predetermined direction to the discharge space. Therefore, phase shift occurs between the reflected waves 61b returning from the bottom surface on the other side in the predetermined direction to the discharge space and the reflected waves 61b returning from the bottom surface on the one side in the predetermined direction to the discharge space. The phase shift may prevent all the reflected waves 61b from returning to the discharge space at the same time unlike the case where no phase shift occurs. The change due to the reflected waves 61b in the density distribution of the laser gas in the discharge space can therefore be suppressed, so that the unstable primary discharge can be suppressed.

FIG. 22 is a cross-sectional view of the groove 137b in Variation 2 of the present embodiment taken along a VZ plane. FIG. 22 does not show those other than the ground plate 137, the groove 137b, and the anode-side sound absorbing member 570 for clarity.

The anode-side sound absorbing member 570 in the present variation differs from the anode-side sound absorbing member 570 in Variation 1 in that the height of the anode-side sound absorbing member 570 in the V direction gradually increases as the anode-side sound absorbing member 570 extends from the one side toward the other side in the Z direction. The surface 570a of the anode-side sound absorbing member 570 remains at the same height across the surface 570a from the one side toward the other side in the Z direction, and is flush with the principal surface of the ground plate 137.

According to the configuration described above, the acoustic waves 61a absorbed by the anode-side sound absorbing member 570 are attenuated because the acoustic waves 61a are repeatedly reflected in the anode-side sound absorbing member 570 a larger number of times on the other side than on the one side in the Z direction. The reflected waves 61b returning from the other side in the predetermined direction to the discharge space may therefore be attenuated by a greater amount than the reflected waves 61b returning from the one side in the predetermined direction to the discharge space, so that the change due to the reflected waves 61b in the density distribution of the laser gas in the discharge space may be suppressed as compared with the case where no attenuation occurs, and the unstable primary discharge may therefore be suppressed.

The chamber 131 according to each of the variations of the present embodiment has been described on the assumption that the one side of the chamber 131 in the Z direction is closer to the monitor module 160 than the other side of the chamber 131 in the Z direction is to the monitor module 160, and that the other side of the chamber 131 in the Z direction is closer to the line narrowing module 145 than the one side of the chamber 131 in the Z direction is to the line narrowing module 145, but the two sides may be swapped.

In Variation 2, the height of the anode-side sound absorbing member 570 does not need to gradually increase in the V direction as the anode-side sound absorbing member 570 extends from the one side toward the other side in the Z direction. The height of the anode-side sound absorbing member 570 may increase stepwise as the anode-side sound absorbing member 570 extends from the one side toward the other side in the Z direction. Furthermore, the anode-side sound absorbing member 570 in each of the present embodiment and the variations thereof may not be disposed in the groove 137b of the ground plate 137 but may be disposed at the principal surface of the ground plate 137.

### 7. Description of Chamber According to Fifth Embodiment

The chamber 131 according to a fifth embodiment will next be described. Note that the same configurations as those described above have the same reference characters, and duplicate description of the same configurations will be omitted unless otherwise particularly described. In addition, in some of the drawings, some of the members are omitted or simplified in some cases for clarity, only some of the same elements have the same reference characters, and some other elements do not have reference characters in some cases.

### 7.1 Configuration

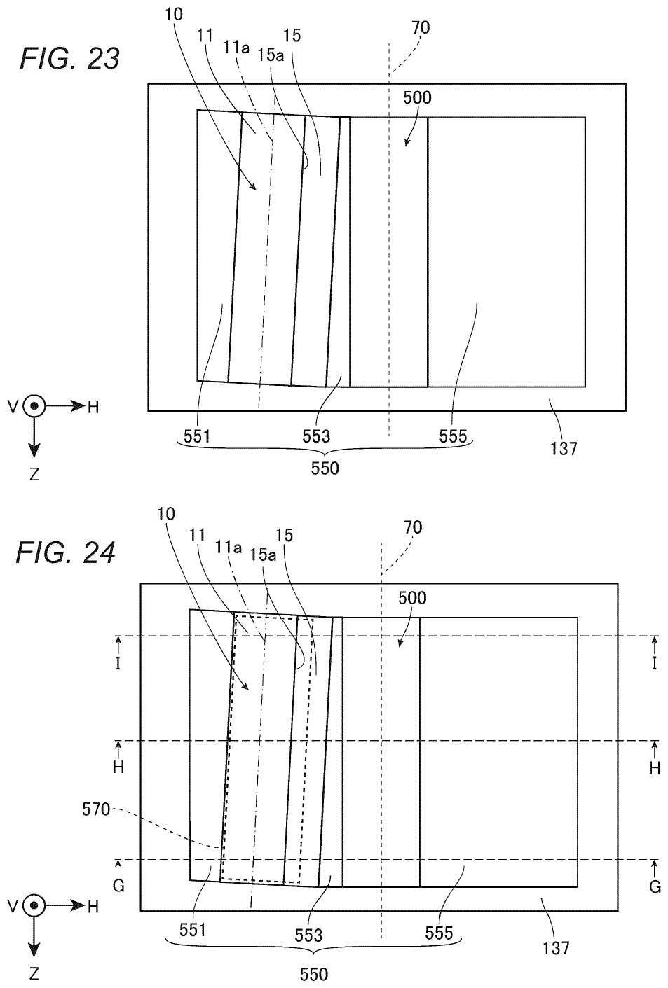

FIG. 23 is a top view of the anode 500 and surroundings thereof in the present embodiment. The chamber 131 according to the present embodiment differs from the chamber 131 according to the first embodiment in that to suppress the effect of the acoustic waves 61a on the performance of the laser light, the longitudinal directions of the dielectric pipe 11 and the outer electrode 15 each incline with respect to an imaginary axis 70, which will be described later, when viewed along the V direction. To facilitate understanding of the inclination described above, FIG. 23 shows a center axis 11a of the dielectric pipe 11, which inclines with respect to the imaginary axis 70, by way of example. The imaginary axis 70 is an axis extending in the Z direction between the cathode 400 and the anode 500. The imaginary axis 70 is located in the middle of the space between the cathode 400 and the anode 500, and coincides with the center axis of the anode 500 when viewed along the V direction. The inclination described above shortens the distance from the imaginary axis 70 to the dielectric pipe 11 as the imaginary axis 70 extends from one side toward the other side in the Z direction. The one side in the Z direction is closer to the monitor module 160 than the other side in the Z direction is to the monitor module 160, and the other side in the Z direction is closer to the line narrowing module 145 than the one side in the Z direction is to the line narrowing module 145. The above description has been made with reference to the dielectric pipe 11, and the same holds true for the inner electrode 13, the outer electrode 15, the end section 15a, the portion of the cover member 551 that is in contact with the dielectric pipe 11, and the cover member 553.

### 7.2 Effects and Advantages

When the distance shortens as described above, the length of the propagation path of the reflected waves 61b returning from the dielectric pipe 11 to the discharge space changes depending on the position in the predetermined direction. The resultant phase shift of the reflected waves 61b returning to the discharge space may prevent the reflected waves 61b from returning to the discharge space at the same time unlike the case where no phase shift occurs. The change due to the reflected waves 61b in the density distribution of the laser gas in the discharge space can therefore be suppressed, so that the unstable primary discharge can be suppressed.

Note that the ground plate 137 in the present embodiment may be provided with the groove 137b and the anode-side sound absorbing member 570 described in the fourth embodiment and the variations thereof.

A variation according to the present embodiment will next be described. FIG. 24 is a top view of the anode 500 and surroundings thereof in the present variation. The dielectric pipe 11, the outer electrode 15, the portion of the cover member 551 that is in contact with the dielectric pipe 11, and the cover member 553 in the present variation each have a longitudinal direction inclining with respect to the imaginary axis 70, as in the fifth embodiment. The ground plate 137 in the present variation is provided with the groove 137b and the anode-side sound absorbing member 570 described in the fourth embodiment. The groove 137b and the anode-side sound absorbing member 570 in the present variation will be described later.

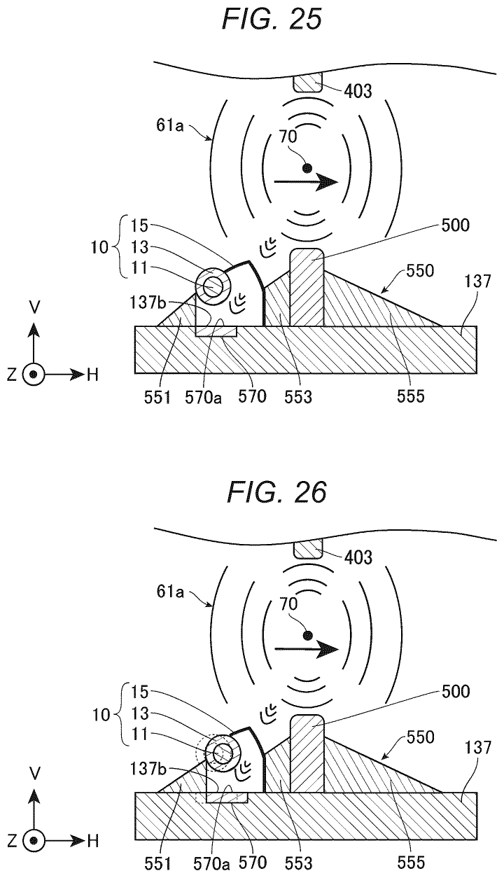

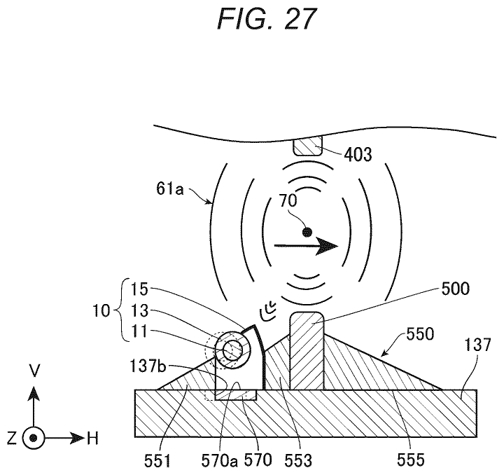

FIG. 25 is a cross-sectional view of the groove 137b and surroundings thereof taken along a line G-G shown in FIG. 24, FIG. 26 is a cross-sectional view of the groove 137b and surroundings thereof taken along a line H-H shown in FIG. 24, and FIG. 27 is a cross-sectional view of the groove 137b and surroundings thereof taken along a line I-I shown in FIG. 24.

The groove 137b and the anode-side sound absorbing member 570 in the present variation differ from those in the fourth embodiment in that the longitudinal direction of each of the groove 137b and the anode-side sound absorbing member 570 inclines with respect to the imaginary axis 70, as the longitudinal direction of the dielectric pipe 11. The anode-side sound absorbing member 570 and the groove 137b therefore extend along the dielectric pipe 11, and the distance from the imaginary axis 70 to the anode-side sound absorbing member 570 shortens as the anode-side sound absorbing member 570 extends from one side toward the other side in the Z direction. In FIG. 24, a portion of the anode-side sound absorbing member 570 that overlaps with the dielectric pipe 11 is indicated by the broken line. In FIG. 26, the dielectric pipe 11, the inner electrode 13, and the anode-side sound absorbing member 570 shown in FIG. 25 are indicated by the broken lines for comparison with those in FIG. 25. In FIG. 27, the dielectric pipe 11, the inner electrode 13, and the anode-side sound absorbing member 570 shown in FIG. 26 are indicated by the broken lines for comparison with those in FIG. 26. Comparison between FIGS. 25, 26, and 27 leads to the understanding that the dielectric pipe 11, the inner electrode 13, and the anode-side sound absorbing member 570 each approach the imaginary axis 70 as they extend from the one side toward the other side in the Z direction.

According to the configuration described above, the length of the propagation path of the reflected waves 61b returning from the anode-side sound absorbing member 570 to the discharge space changes depending on the position in the predetermined direction. The resultant phase shift of the reflected waves 61b returning to the discharge space may prevent the reflected waves 61b from returning to the discharge space at the same time unlike the case where no phase shift occurs. The change due to the reflected waves 61b in the density distribution of the laser gas in the discharge space can therefore be suppressed, so that the unstable primary discharge can be suppressed.

The chamber 131 according to the present variation has been described with reference to the groove 137b having a depth in the V direction that is fixed in the Z direction and the anode-side sound absorbing member 570 having a height in the V direction that is fixed in the Z direction, which have been described in the fourth embodiment. The groove 137b and the anode-side sound absorbing member 570 in the present variation, however, only need to incline with respect to the imaginary axis 70 as described above, and the groove 137b and the anode-side sound absorbing member 570 described in Variation 1 or 2 of the fourth embodiment may be used. Furthermore, the anode-side sound absorbing member 570 in the present variation may not be disposed in the groove 137b of the ground plate 137 but may be disposed at the principal surface of the ground plate 137. The preliminary ionization electrode 10 in the present variation may not incline with respect to the imaginary axis 70 unlike the present embodiment. The chamber 131 in each of the present embodiment and the present variation has been described on the assumption that one side of the chamber 131 in the Z direction is closer to the monitor module 160 than the other of the chamber 131 in the Z direction is to the monitor module 160, and that the other side of the chamber 131 in the Z direction is closer to the line narrowing module 145 than the one side of the chamber 131 in the Z direction is to the line narrowing module 145, but the two sides may be swapped.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined. The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A chamber of a gas laser apparatus, the chamber configured to encapsulate a laser gas in an internal space, the chamber comprising:
an anode disposed in the internal space and having a longitudinal direction along a predetermined direction;
a cathode disposed in the internal space and including a base and a discharge section protruding from the base toward the anode, the cathode having a longitudinal direction along the predetermined direction, the cathode being separate from and facing the anode;
a cathode-side cover disposed in the internal space, being separate from a portion of the base and the discharge section, and covering the base; and
a cathode-side sound absorbing member provided in a gap between the portion of the base and the cathode-side cover.

2. The chamber of the gas laser apparatus according to claim 1, wherein
the cathode-side sound absorbing member is disposed at the base.

3. The chamber of the gas laser apparatus according to claim 1, wherein
the cathode-side sound absorbing member is disposed at the cathode-side cover.

4. The chamber of the gas laser apparatus according to claim 1, wherein
the cathode-side sound absorbing member is configured with multiple cathode-side sound absorbing members disposed at the base and the cathode-side cover.

5. The chamber of the gas laser apparatus according to claim 4, wherein
the cathode-side sound absorbing member disposed at the base faces the cathode-side sound absorbing member disposed at the cathode-side cover.

6. The chamber of the gas laser apparatus according to claim 1, wherein
the cathode-side sound absorbing member is disposed in the gap at a position farthest from a discharge space between the cathode and the anode.

7. The chamber of the gas laser apparatus according to claim 1, wherein
a surface of the cathode-side cover that is in contact with the gap is perpendicular to a direction from the anode toward the cathode, extends in the predetermined direction, and inclines away from the anode as the surface extends from one side toward the other side in the predetermined direction.

8. The chamber of the gas laser apparatus according to claim 7, wherein
the cathode-side sound absorbing member extends in the predetermined direction and is disposed at the base, and
a height of the cathode-side sound absorbing member in the direction from the anode toward the cathode increases as the cathode-side sound absorbing member extends from the one side toward the other side in the predetermined direction.

9. The chamber of the gas laser apparatus according to claim 1, further comprising:
a ground plate which is disposed in the internal space and at which the anode is disposed;
an anode-side cover disposed on the ground plate, and being separate alongside from and covering the anode; and
an anode-side sound absorbing member provided in a gap between the anode-side cover and the anode.

10. The chamber of the gas laser apparatus according to claim 9, wherein
the anode-side sound absorbing member is disposed at the anode-side cover.

11. The chamber of the gas laser apparatus according to claim 9, wherein
the anode-side sound absorbing member is disposed at the anode.

12. The chamber of the gas laser apparatus according to claim 9, wherein
the anode-side sound absorbing member is configured with multiple anode-side sound absorbing members disposed at the anode-side cover and the anode.

13. The chamber of the gas laser apparatus according to claim 1, further comprising:
a ground plate which is disposed in the internal space and at which the anode is disposed; and
an anode-side sound absorbing member disposed at the ground plate in a groove provided alongside the anode.

14. The chamber of the gas laser apparatus according to claim 13, wherein
the groove extends in the predetermined direction, and
a depth of the groove in a direction perpendicular to the predetermined direction and perpendicular to a principal surface of the ground plate increases as the groove extends from one side toward the other side in the predetermined direction.

15. The chamber of the gas laser apparatus according to claim 14, wherein
the anode-side sound absorbing member extends in the predetermined direction, and
a height of the anode-side sound absorbing member in the direction perpendicular to the principal surface of the ground plate is fixed as the anode-side sound absorbing member extends from the one side toward the other side in the predetermined direction.

16. The chamber of the gas laser apparatus according to claim 14, wherein
the anode-side sound absorbing member extends in the predetermined direction, and
a height of the anode-side sound absorbing member in the direction perpendicular to the principal surface of the ground plate increases as the anode-side sound absorbing member extends from the one side toward the other side in the predetermined direction.

17. The chamber of the gas laser apparatus according to claim 1, further comprising
a preliminary ionization electrode provided alongside the anode,
wherein the preliminary ionization electrode includes a dielectric pipe, a preliminary ionization inner electrode disposed in the dielectric pipe and extending along a longitudinal direction of the dielectric pipe, and a preliminary ionization outer electrode extending along the longitudinal direction of the dielectric pipe and including an end section facing the dielectric pipe, and
a distance from an imaginary axis extending along the predetermined direction between the cathode and the anode to the dielectric pipe decreases as the imaginary axis extends from one side to the other side in the predetermined direction.

18. The chamber of the gas laser apparatus according to claim 17, further comprising:
a ground plate which is disposed in the internal space and at which the anode is disposed; and
an anode-side sound absorbing member disposed at the ground plate on the side alongside the anode,
wherein a distance from the imaginary axis to the anode-side sound absorbing member decreases as the imaginary axis extends from one side to the other side in the predetermined direction.

19. A gas laser apparatus comprising a chamber configured to encapsulate a laser gas in an internal space, the chamber including
an anode disposed in the internal space and having a longitudinal direction along a predetermined direction,
a cathode disposed in the internal space and including a base and a discharge section protruding from the base toward the anode, the cathode having a longitudinal direction along the predetermined direction, the cathode being separate from and facing the anode,
a cathode-side cover disposed in the internal space, being separate from a portion of the base and the discharge section, and covering the base, and
a cathode-side sound absorbing member provided in a gap between the portion of the base and the cathode-side cover.

20. An electronic device manufacturing method comprising:
generating laser light by using a gas laser apparatus including a chamber configured to encapsulate a laser gas in an internal space;
outputting the laser light to an exposure apparatus; and
exposing a photosensitive substrate to the laser light in the exposure apparatus to manufacture electronic devices,
the chamber including
an anode disposed in the internal space and having a longitudinal direction along a predetermined direction,
a cathode disposed in the internal space and including a base and a discharge section protruding from the base toward the anode, the cathode having a longitudinal direction along the predetermined direction, the cathode being separate from and facing the anode,
a cathode-side cover disposed in the internal space, being separate from a portion of the base and the discharge section, and covering the base, and
a cathode-side sound absorbing member provided in a gap between the portion of the base and the cathode-side cover.
